(19) United States
(12) Patent Application Publication
(10) Pub. No.: US 2009/0103440 A1
(43) Pub. Date: Apr. 23, 2009

(54) Collision avoidance for uplink VoIP transmission

(75) Inventors: Haifeng Wang, Shanghai (CN); Bin Chen, Hubei (CN); Bin Wang, Beijing (CN); Jing Xu, Shanghai (CN); Ting Zhou, Shanghai (CN)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 11/977,228

(22) Filed: Oct. 23, 2007

(51) Int. Cl. G06F 11/30

(52) U.S. Cl. 370/237

(57) ABSTRACT

Disclosed is a method the includes determining if a collision will occur between a transmission from a first user equipment that uses a persistently assigned uplink resource (such as for VoIP packet transmissions) and a retransmission from a second user equipment that uses a synchronous non-adaptive automatic repeat request procedure (e.g., synchronous, non-adaptive HARQ). If it is determined that a collision will occur, the method dynamically allocates the first user equipment to another uplink resource to avoid the collision, while if it is determined that the collision will not occur, the first user equipment is not dynamically allocated another uplink resource so that the first user equipment sends its transmission using the persistently assigned uplink resource. The embodiments of this invention pertain to both the base station (e.g., an evolved Node-B) and the user equipment.

### TECHNICAL FIELD

The exemplary and non-limiting embodiments of this invention relate generally to wireless communication systems, methods, devices and computer program products and, more specifically, relate to techniques for avoiding collisions between transmissions from mobile communication devices.

### BACKGROUND

Various abbreviations that appear in the specification and/or in the drawing figures are defined as follows:
3GPP third generation partnership project
UTRAN universal terrestrial radio access network
Node B base station
UE user equipment
EUTRAN evolved UTRAN
aGW access gateway
eNB EUTRAN Node B (evolved Node B)
PDU protocol data unit
PRB physical resource block
PHY physical
LTE long term evolution
ARQ automatic repeat request
HARQ hybrid automatic repeat request
OFDMA orthogonal frequency division multiple access
SC-FDMA single carrier, frequency division multiple access
TTI transmission time interval
UL uplink
DL downlink
QoS quality of service
RB resource block
VoIP voice over internet protocol
CATT China Academy of Telecommunications Technology
RITT Research Institute of Telecommunication Transmission
DRX discontinuous reception
AMR adaptive multi-rate

A proposed communication system known as evolved UTRAN (E-UTRAN, also referred to as UTRAN-LTE or as E-UTRA) is currently under discussion within the 3GPP. The current working assumption is that the DL access technique will be OFDMA, and the UL access technique will be SC-FDMA.

One specification of interest to these and other issues related to the invention is 3GPP TS 36.300, V8.2.0 (2007-09), 3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8), incorporated by reference herein in its entirety.

In LTE the general model for UL resource scheduling is that the eNB allocates resource blocks to UEs based on their UL transmit buffers and QoS profiles and sends scheduling grants to UEs using L1/L2 signaling. Such a model allows for efficient channel sensitive scheduling to maximize throughput. However, this approach to scheduling is not effective for VoIP due to the characteristics of the traffic and the large number of users.

In general, VoIP originates from a speech coder (e.g., an AMR speech coder) that produces output frames of coded speech at a regular frame rate (typically 20 msec) during periods of speech, or alternatively parameters relating to background noise conditions during silence periods. Unlike circuit switched (CS) speech, VoIP is routed through a packet switched (PS) IP network and typically accumulates a relatively large amount of header information, which is normally compressed. Due to the routing through the PS network there is a certain amount of jitter in the timing of received VoIP packets at an edge node of the radio network.

A general reference with regard to AMR speech coding and decoding can be found in 3GPP TS 26.071 V7.0.1 (2007-07), Technical Specification, 3rd Generation Partnership Project; Technical Specification Group Services and System Aspects; Mandatory speech CODEC speech processing functions; AMR speech CODEC; General description (Release 7), and in the various documents referenced therein in Section 2, “References”.

Typical VoIP packets can take the form of:

packets containing uncompressed headers (these are typically large (40 bytes) but also infrequent (arising at session start and occasionally during the session, in particular following a run of block errors));
packets containing voice and compressed headers; typically, e.g., 28 bytes for 7.95 kbps AMR;
packets containing silence parameters and compressed headers; typically 15 bytes; and
session initiation protocol (SIP) packets (infrequent; mainly at session start).

Although the uncompressed header packets are infrequent, they require additional air interface resources when they occur.

In order to avoid echo or delay jitter effects the VoIP packets should have a latency budget, typically 10-20 msec, in the physical layer.

In that VoIP traffic arrives as small packets that need to be transmitted within a narrow time frame, the scheduling of a large number of users within a TTI would lead to an untenably large L1/L2 control signaling overhead. Further, the QoS requirements limit the effectiveness of time/frequency scheduling.

Thus, for VoIP traffic the use of so called persistent scheduling is more appropriate. Reference in this regard may be made to R2-070188, “Scheduling for VoIP”. Siemens Networks, 3GPP TSG RAN WG2#56bis, Sorrento, Italy, 15-19 Jan. 2007. In general, persistent scheduling implies that a resource pattern is assigned to a UE for a relatively long period of time, without the need for continual scheduling grants over the L1/L2 control channel. With persistent scheduling, a VoIP UE is allowed to use the allocated physical resource blocks once every 20 ms, as depicted in FIG. 1.

Reduced signaling overhead and simplicity are the two main advantages for supporting persistent scheduling in LTE. Reference in this regard may be had to R2-070041, “Problems of Persistent Scheduling”, Ericsson, 3GPP TSG RAN WG2#56bis, Sorrento, Italy, 15-19 Jan. 2007.

The main advantage of persistent scheduling is that UL scheduling grants do not need to be transmitted for each VoIP frame, which reduces the control signaling overhead and thereby increases the system capacity. This is particularly beneficial as the L1/L2 control signaling consumes a significant fraction of the entire spectrum and the available transmission power. Another advantage of persistent scheduling is its simplicity, at least in terms of algorithm complexity.

However, the use of persistent scheduling also has drawbacks, such as wasted resources and the potential for collision with non-adaptive HARQ.

Further in this regard, synchronous HARQ uses a fixed interval between the current time (frame number) and the corresponding retransmission HARQ process, which has been defined for the LTE uplink in 3GPP TS 36.300.

Synchronous HARQ schemes are further classified as adaptive or non-adaptive in terms of transmission attributes, e.g., the resource block (RB) allocation, modulation and transport block size, and the duration of the retransmission. Control channel requirements are described for each case in 3GPP TR25.814 V7.1.0 (2006-09), Technical Report, 3rd Generation Partnership Project; Technical Specification Group Radio Access Network; Physical layer aspects for evolved Universal Terrestrial Radio Access (UTRA) (Release 7), as follows.

Adaptive HARQ implies the transmitter may change some or all of the transmission attributes used in each retransmission as compared to the initial transmissions (e.g. due to changes in the radio conditions). Hence, the associated control information needs to be transmitted with the retransmission. The changes considered are modulation, resource block allocation and duration of transmission.

Non-Adaptive HARQ implies that changes, if any, in the transmission attributes for the retransmissions are known to both the transmitter and receiver at the time of the initial transmission. Hence, the associated control information need not be transmitted for the retransmission.

When using adaptive synchronous HARQ in E-UTRAN, the control signaling overhead must be considered. It was concluded in R2-070115, “Collision Avoidance While Using Synchronous HARQ”, CATT, RITT, 3GPP TSG RAN WG2#56bis, Sorrento, Italy, 15-19 Jan. 2007, that the main difference in control message bits between asynchronous HARQ and adaptive synchronous HARQ is the HARQ process ID. In other words, the major advantage of synchronous HARQ, i.e. reduction of the control signaling overhead, appears not to be so great if one selects to use adaptive synchronous HARQ in E-UTRAN.

At least one currently perceived problem relates to the fact that the use of synchronous non-adaptive HARQ implies that retransmissions are restricted to occur at the same resource blocks and known time instants. This can lead to collisions when other mechanisms are adopted at the same time, such as in persistent scheduling. One such collision is depicted in FIG. 2. If the dynamically scheduled transmission of UE_2 does not succeed in the first HARQ transmission attempt, a synchronous HARQ retransmission of UE_2 will collide with the persistently scheduled transmission of UE_1. The occurrence of a collision will result in a decoding error at the receiver side (at the eNB) due to orthogonal resource usage. What is more, because the HARQ retransmission probability is not low (10%˜20%), the collision probability is high (>10%). Thus, certain procedures are needed to overcome the collision problem.

Various techniques that have been proposed to overcome the collision problem include the following.

One solution is presented in the above referenced R2-070115, “Collision Avoidance While Using Synchronous HARQ”. In this approach it is proposed to avoid collision while using non-adaptive HARQ with a resource prohibit. The initial transmission of the synchronous HARQ is forbidden when its retransmission may conflict with persistent scheduling. This method needs to reserve resources to avoid a collision, even if the collision would not occur. FIG. 3 illustrates this approach.

In FIG. 3, the time/frequency resource indicated with an asterisk (*) is allocated to a UE_1 with persistent scheduling having a 20 ms period. If a synchronous HARQ UE (the retransmission interval is 5 ms) whose maximum retransmission number is 2, performs its initial transmission at one of the time/frequency resources indicated with #, it is possible to produce a collision during TTI T. The conflict is eliminated, however, if the initial transmission of the synchronous HARQ with two retransmissions is, at most, forbidden to occur in those RBs indicated with the * time/frequency.

One advantage of avoiding collisions in the initial transmissions is reducing control overhead of non-adaptive synchronous HARQ, while making it unnecessary to modify the mechanism of the currently specified synchronous HARQ. However, a disadvantage of this technique is the significantly reduced efficiency of resource utilization.

Another proposed solution to the collision problem is found in R2-070055, “Scheduling for maximizing VoIP capacity”, Ericsson, 3GPP TSG RAN WG2#56bis, Sorrento, Italy, 15-19 Jan. 2007. R2-070055 presents a semi-dynamic scheduling of VoIP to overcome the collision problem, which is shown in FIG. 4. The resource for UL VoIP transmission is allocated by the eNB dynamically and is sent to the UE via a scheduling grant. To reduce the L1/L2 signaling overhead, the eNB is said to pre-configure a set of resource assignments and transport formats for VoIP scheduling. Thus, a short grant can be used to indicate when the pre-configured resource shall be used by the UE. The short grant only has to indicate the UE identification (id) and an index to one of the pre-allocated resource sets.

In that a VoIP UE is scheduled dynamically within a pre-configured set, the collision may be avoided, or the potential for a collision to occur may be reduced (dependent on the set size). However, the control signaling overhead is a significant disadvantage as compared to persistent scheduling.

In R2-070020, “Scheduling of LTE UL VoIP”, Nokia, 3GPP TSG RAN WG2#56bis, Sorrento, Italy, 15-19 Jan. 2007, incorporated by reference herein in its entirety, there is presented a semi-persistent scheduling of UL VoIP, shown herein in FIG. 5. In this approach the initial transmission of VoIP is allocated persistently without L1/L2 control signaling, and retransmissions are allocated dynamically using the L1/L2 control channel. The UE monitors the L1/L2 control channel in all, or in preconfigured, TTIs (DRX).

### SUMMARY

The foregoing and other problems are overcome, and other advantages are realized, by the use of the exemplary embodiments of this invention.

In a first aspect thereof the exemplary embodiments of this invention provide a method that includes determining if a collision will occur between a transmission from a first user equipment that uses a persistently assigned uplink resource and a retransmission from a second user equipment that uses a synchronous non-adaptive automatic repeat request procedure. If it is determined that a collision will occur, the method dynamically allocates the first user equipment to another uplink resource to avoid the collision, while if it is determined that the collision will not occur, the first user equipment is not dynamically allocated another uplink resource so that the first user equipment sends its transmission using the persistently assigned uplink resource.

In another aspect thereof the exemplary embodiments of this invention provide an apparatus that includes a radio frequency transceiver configurable to perform uplink and downlink radio frequency communications with a plurality of user equipment. The apparatus further includes a scheduler responsive to a determination being made that a collision will occur between a transmission from a first user equipment, that is allocated a persistently assigned uplink resource, and a retransmission from a second user equipment that uses a synchronous non-adaptive automatic repeat request procedure, to allocate the first user equipment a different uplink resource for the transmission to avoid the collision.

In another aspect thereof the exemplary embodiments of this invention provide an apparatus that includes means for transceiving uplink and downlink radio frequency communications with a plurality of user equipment, and means for determining if a collision will occur between a transmission from a first user equipment, that uses a persistently assigned uplink resource for transmitting VoIP packets, and a retransmission from a second user equipment that uses synchronous non-adaptive HARQ for retransmitting data in response to receipt of a NACK. The determining means is configurable to respond to a determination that the collision will occur for dynamically allocating the first user equipment a different uplink resource block for transmission of a next VoIP packet to avoid the collision, and for signaling information to the first user equipment via the transceiver means for identifying the different uplink resource block.

In a further aspect thereof the exemplary embodiments of this invention provide a method that includes monitoring a downlink control channel when operating a user equipment with a persistently assigned uplink resource and, in response to receiving an allocation of a different uplink resource from the downlink control channel, using the allocated different uplink resource to transmit a next packet.

In a still further aspect thereof the exemplary embodiments of this invention provide an apparatus having a radio frequency transceiver configurable to perform uplink and downlink radio frequency communications with a base station and a controller, coupled with the transceiver, and configurable to monitor a downlink control channel, when operating with a persistently assigned uplink resource, to receive an allocation of a different uplink resource from the downlink control channel, said controller further configurable to use the allocated different uplink resource to transmit a next packet.

### BRIEF DESCRIPTION OF THE DRAWINGS

In the attached Drawing Figures:

FIG. 1 is a simplified illustration of persistent scheduling.

FIG. 2 shows the collision of a dynamically scheduled first UE (HARQ retransmission) with a persistent allocation of a second UE.

FIG. 3 shows a previously proposed technique to avoid the situation shown in FIG. 2 by the use of a resource prohibit.

FIG. 4 shows a previously proposed technique to avoid the situation shown in FIG. 2 by the use of semi-dynamic scheduling.

FIG. 5 shows a previously proposed technique that employs semi-persistent allocation of UL VoIP.

FIG. 6 shows a simplified block diagram of various electronic devices that are suitable for use in practicing the exemplary embodiments of this invention.

FIG. 7 illustrates, in accordance with exemplary embodiments of this invention, an adaptive scheduling of UL VoIP to avoid collisions.

FIG. 8 illustrates two Tables, where Table 1 tabulates relative signaling requirements, and Table 2 tabulates the relative performance, of various prior proposals and the exemplary embodiments of this invention.

FIG. 9 is a logic flow diagram that is descriptive of a method, and the execution of computer program instructions stored in a tangible, computer-readable storage medium of a base station, such as an eNB, in accordance with exemplary embodiments of this invention.

FIG. 10 is a logic flow diagram that is descriptive of a method, and the execution of computer program instructions stored in a tangible, computer-readable storage medium of a user equipment, in accordance with exemplary embodiments of this invention.

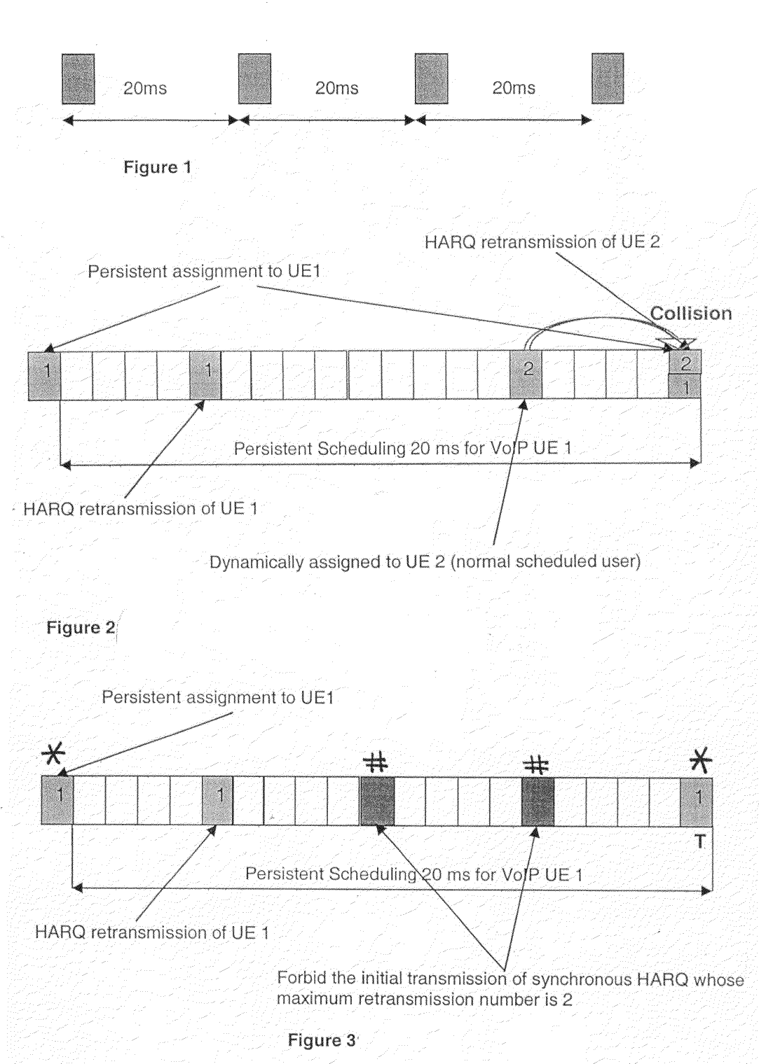

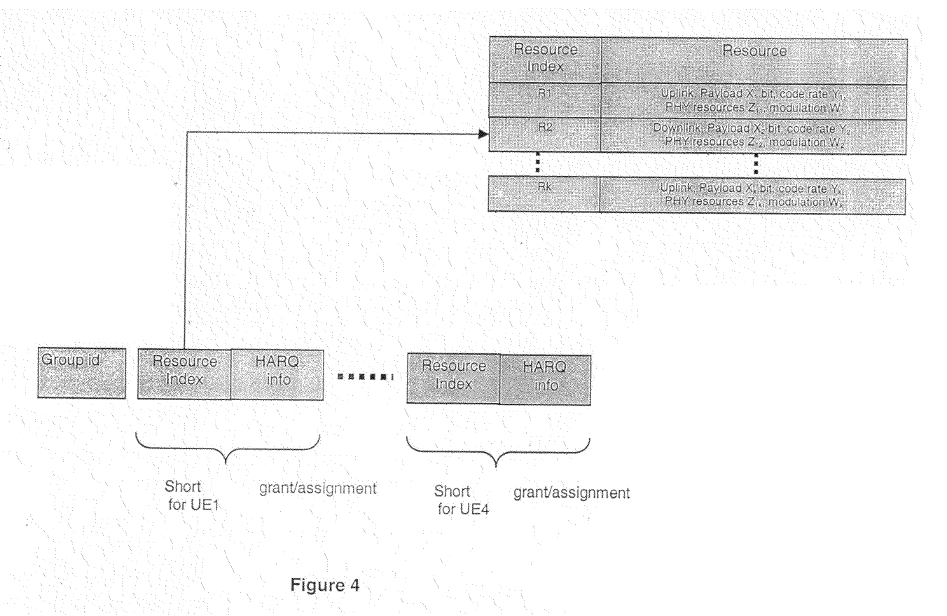

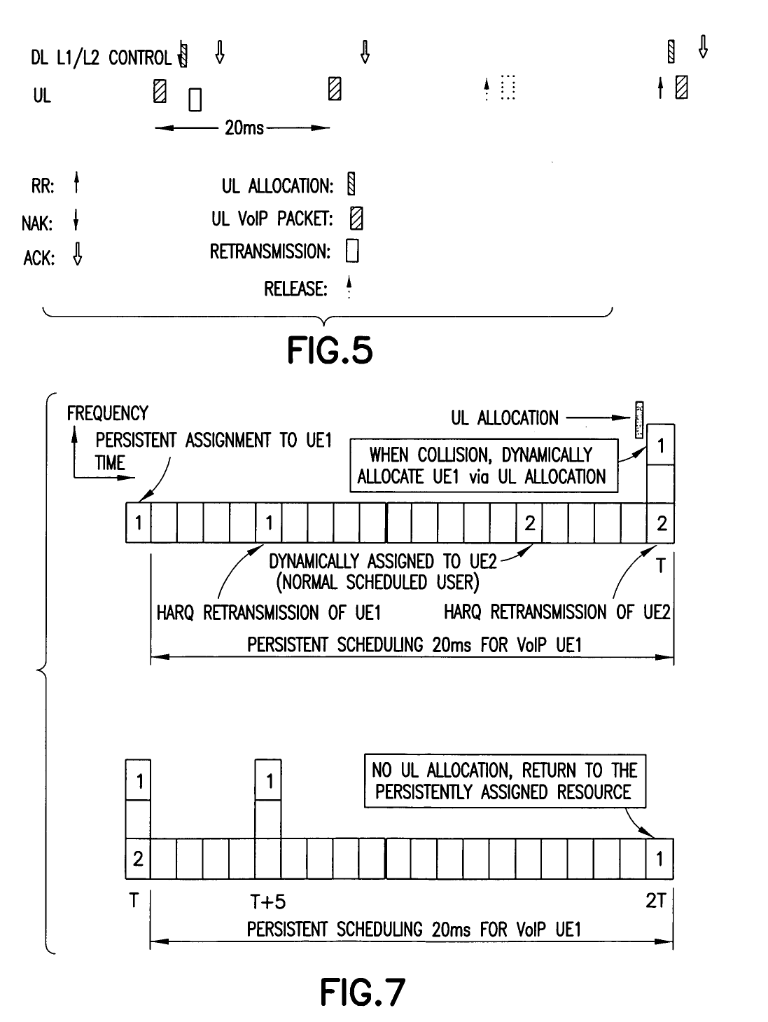

### DETAILED DESCRIPTION

The inventors have realized that the use of semi-persistent scheduling alone cannot solve the collision problem discussed above, and that the use of adaptive HARQ for all users is needed to avoid collision. In FIG. 2, if the UE_2 (a normally scheduled UE) uses adaptive HARQ, the retransmissions of UE_2 can be allocated on any free resources and can thus avoid collision with VoIP UE_1.

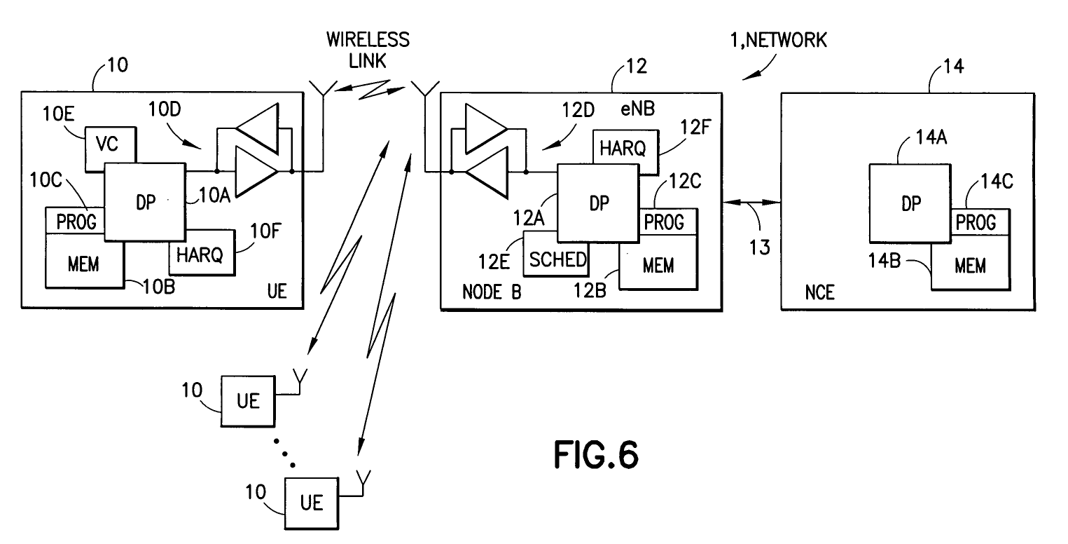

Reference is made first to FIG. 6 for illustrating a simplified block diagram of various electronic devices that are suitable for use in practicing the exemplary embodiments of this invention. In FIG. 6 a wireless network 1 is adapted for communication with a plurality of UEs 10 via an eNodeB (base station) 12, also referred to herein as eNB 12. The network 1 may include a network control element (NCE) 14. The UE 10 includes a data processor (DP) 10A, a memory (MEM) 10B that stores a program (PROG) 10C, and a suitable radio frequency (RF) transceiver 10D for bidirectional wireless communications with the eNB 12, which also includes aDP 12A, a MEM 12B that stores a PROG 12C, and a suitable RF transceiver 12D. The eNB 12 is coupled via a data path 13 to the NCE 14, such as an aGW, that also includes a DP 14A and a MEM 14B storing an associated PROG 14C.

It may be assumed that the UE 10 will include a suitable voice coder (VC) 10E, such as an AMR voice coder, that is used at least when functioning in a VoIP mode of operation. The UE 10 will also include a HARQ functional block or module 10F.

The eNB 12 is shown to include a scheduler module or function (SCHED) 12E that is operated in accordance with the exemplary embodiments of this invention, as described below, and will also include a HARQ functional block or module 12F. The various modules and functions 10F, 12E and 12F, as well as the voice coder scheduler module 10E, may be implemented using hardware, software (including firmware), or with a combination of hardware and software.

The PROGs 10C and 12C may thus be assumed to include program instructions that, when executed by the associated DP, enable the electronic device to operate in accordance with the exemplary embodiments of this invention, as will be discussed below in greater detail. That is, the exemplary embodiments of this invention may be implemented at least in part by computer software executable by the DP 10A of the UE 10 and by the DP 12A of the eNB 12, or by hardware, or by a combination of software and hardware.

In general, the various embodiments of the UEs 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, flash memory, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

The exemplary embodiments of this invention avoid the occurrence of a collision between a UE 10 having a HARQ retransmission and another UE 10 having a persistent scheduling for, as a non-limiting example, a VoIP application. In the exemplary embodiments of this invention the allocation of a VoIP UE 10 is adjusted or controlled while maintaining the mechanism of synchronous non-adaptive HARQ. Thus, and as is depicted in FIG. 7, an adaptive scheduling of UL VoIP is employed to avoid collisions.

If the eNB scheduler 12E has knowledge that a collision will occur at time T, an UL allocation is sent to VoIP UE_1, where the UE_1 is allocated dynamically to other free UL resource to avoid the collision. Thus, VoIP UEs 10 monitor the L1/L2 control channel in pre-configured (pre-determined) TTIs for initial transmission. If no valid UL allocation is given to the VoIP UE 10, the VoIP UE 10 sends its transmission using the persistently assigned resource. Because synchronous non-adaptive HARQ is assumed to also be in operation, the retransmission of VoIP UE_1 at time T+5 will use the newly allocated resource if UE_1 is allocated dynamically to the another free resource at time T.

In other words, the adaptive scheduling of the UL VoIP functions as persistent scheduling when no collision is expected to occur, and it functions as dynamic scheduling when a collision is expected to occur.

Unlike the previous proposal in R2-070041, the VoIP UE 10 is scheduled dynamically only when a collision can be expected to occur. In that the collision probability is generally about 10%˜20%, the use of the exemplary embodiments of this invention beneficially reduce the L1/L2 control signaling overhead as compared to the proposal in R2-070041. It should be noted that the short grant that is proposed in R2-070055, or another similar or equivalent approach, can be employed to further reduce the L1/L2 control signaling overhead.

As such, it can be appreciated that the exemplary embodiments of this invention enable the eNB scheduler 12E to adjust the UL allocation of the VoIP UE 10, while preserving the use of the synchronous non-adaptive HARQ.

When a collision will occur, the UL allocation signaling is sent to the VoIP UE 10. The UE 10 is thus allocated dynamically to another free UL resource block (RB) to avoid the collision. When it is known that a collision will not occur, no UL allocation signaling need be sent to the VoIP UE 10, and the VoIP UE then sends its transmission using the persistently assigned resource.

Note in FIG. 7 that if a retransmission by UE_1 is required then UE_1, after it is assigned to the new UL resource at time T, uses the newly assigned UL resource for the retransmission at T+5. Note further that if there is no subsequent UL allocation, then UE_1 automatically returns to the originally allocated UL resource. That is, when the eNB scheduler 12E determines that a collision will not occur between UE_1 and UE_2, when UE_1 uses its original persistently assigned UL RB, then the absence of an UL allocation from the eNB 12 is interpreted by the UE 10 as permission to return to the originally assigned UL resource for the next UL transmission (e.g., to transmit the next new VoIP packet).

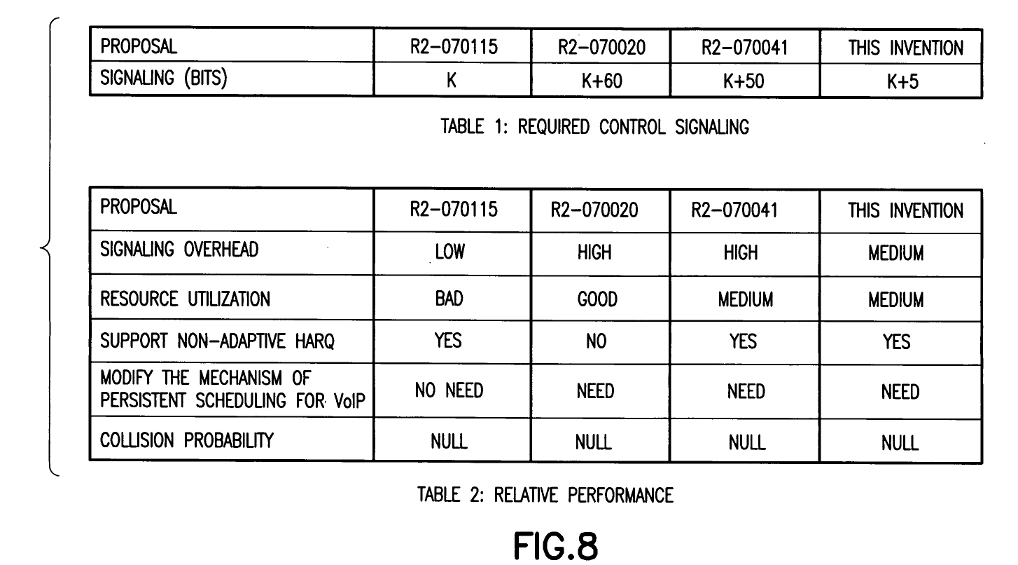

The current assumptions in RAN 1 indicate that the size of the scheduling information needed for uplink grants is about 46 bits (see R2-062263, “First quantification of downlink control channel overhead”, Samsung, 3GPP TSG RAN2#54, Tallinn, Estonia, 28 Aug.-2 Sep. 2006). The adaptive synchronous HARQ is 5 bits (HARQ process ID) less than the asynchronous HARQ. For simplicity, assume a case where the control signaling requires 40 bits for adaptive synchronous HARQ, the HARQ retransmission probability is 10%, as is the collision probability, the HARQ retransmission number is set to 1, and that there are 10 dynamically scheduled UEs 10 and 5 VoIP UEs 10 per TTI. In this example, it may also be assumed that the short grant is used. According to R2-070055, the short grant averages about 10 bits. If it is further assumed that the proposal of R2-070115 (persistent scheduling of VoIP+synchronous non-adaptive HARQ) requires K bits for signaling, the proposal found in R2-070020 will need K+(10+5)*40*0.1 bits for signaling, and the proposal of R2-070041 needs K+5*10 bits signaling, then the use of the exemplary embodiments of this invention uses K+5*10*0.1 bits for signaling. Table 1 in FIG. 8 tabulates the relative signaling requirements, while Table 2 tabulates the relative performance of the various proposals and the exemplary embodiments of this invention.

In accordance with the exemplary embodiments of this invention, adaptive scheduling of the UL of the VoIP UE 10 is performed to avoid a collision for the persistently scheduled LTE uplink (VoIP transmission). If a collision occurs, an UL allocation is sent to the VoIP UE 10. The VoIP UE 10 is dynamically allocated to another free RB to avoid collision. When the collision does not occur, no UL allocation need be given to the VoIP UE 10, and the VoIP UE sends its transmission using the persistently assigned resource. The use of the exemplary embodiments thus avoids collisions while achieving high resource utilization with low control signaling overhead.

Based on the foregoing it should be apparent that the exemplary embodiments of this invention provide a method, apparatus and computer program product(s) to enable an adjustment of the allocation of the VoIP UE while maintaining the use of synchronous non-adaptive HARQ.

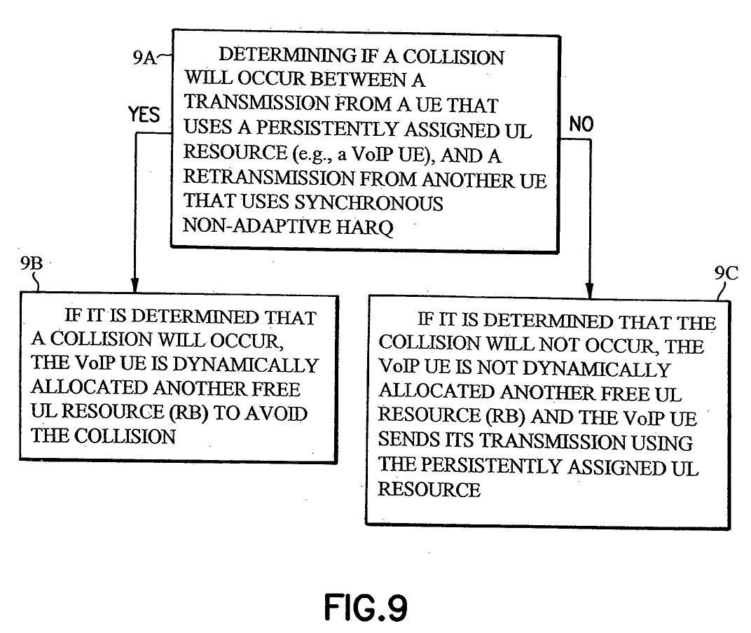

Referring to FIG. 9, in accordance with a method of this invention, and the execution of computer program instructions stored in a tangible, computer-readable storage medium (such as the program 12C stored in the memory 12B), at Block 9A a determination is made if a collision will occur between a transmission from a VoIP UE, that uses a persistently assigned UL resource, and a retransmission from another UE that uses synchronous non-adaptive HARQ. Note that because the scheduler 12E of the eNB 12 is aware of all UL allocations, the retransmission status, and the operating mode of each UE 10, the scheduler 12E is enabled to detect that a collision will occur between a VoIP UE and another UE using synchronous non-adaptive HARQ. At Block 9B, if it is determined that a collision will occur, the VoIP UE is dynamically allocated another free UL resource (RB) to avoid the collision, while at Block 9C, if it is determined that the collision will not occur, the VoIP UE is not dynamically allocated another free UL resource (RB) and the VoIP UE sends its transmission using the persistently assigned UL resource.

The method of the preceding paragraph, where the VoIP UE is dynamically allocated the another free UL resource using L1/L2 control signaling.

The method of the preceding paragraphs, where the VoIP UE is dynamically allocated the another free UL resource using a short grant.

The method of the preceding paragraphs, executed at least in part by a scheduler function of an eNB.

Further in accordance with an apparatus of this invention, an eNB comprises a scheduler function that is configurable to determine if a collision will occur between a transmission from a VoIP UE, that uses a persistently assigned UL resource, and a retransmission from another UE that uses synchronous non-adaptive HARQ. If the scheduler function determines that a collision will occur, the VoIP UE is dynamically allocated another free UL resource (RB) to avoid the collision, while if it is determined that the collision will not occur, the VoIP UE is not dynamically allocated another free UL resource (RB) such that the transmission from the VoIP UE is received from the persistently assigned UL resource.

The apparatus of the preceding paragraph, where the VoIP UE is dynamically allocated the another free UL resource using L1/L2 control signaling.

The apparatus of the preceding paragraphs, where the VoIP UE is dynamically allocated the another free UL resource using a short grant.

Note that the exemplary embodiments of this invention also provide a method and apparatus, and computer program instructions, to operate the UE to monitor a L1/L2 control channel to receive, when functioning as a VoIP UE with a persistently assigned UL resource, a dynamic allocation of another UL resource that is predetermined to avoid a collision with a retransmission from another UE that uses synchronous non-adaptive HARQ.

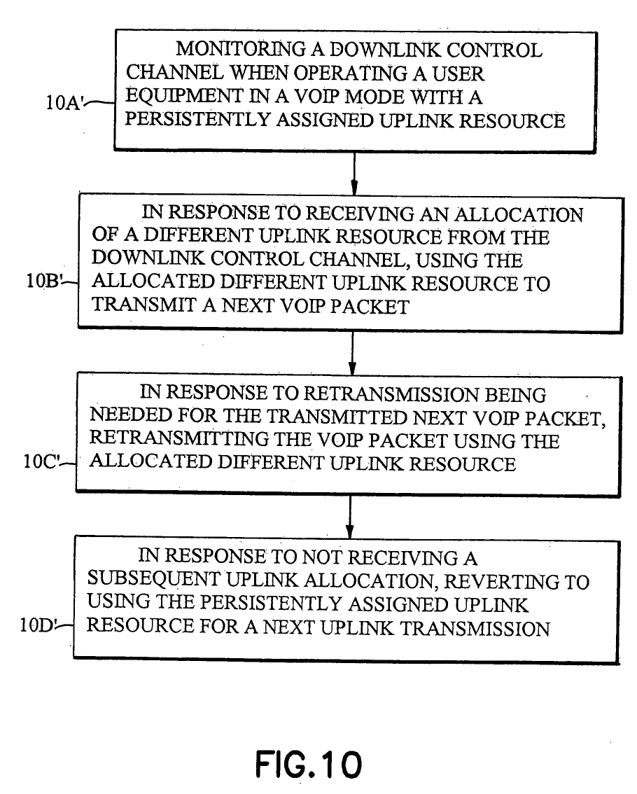

Further in this regard reference is made to FIG. 10, where in accordance with a method of this invention, and the execution of computer program instructions stored in a tangible, computer-readable storage medium (such as the program 10C stored in the memory 10B), at Block 10A′ there is performed a step of monitoring a downlink control channel when operating a user equipment in a voice over internet protocol mode with a persistently assigned uplink resource and, at Block 10B′, in response to receiving an allocation of a different uplink resource from the downlink control channel, using the allocated different uplink resource to transmit a next voice over internet protocol packet.

In accordance with the exemplary embodiments the allocated different uplink resource is predetermined to avoid a collision between the transmission of the next voice over internet protocol packet and a retransmission from another user equipment.

The method may further include, at Block 10C′, in response to retransmission being needed for the transmitted next voice over internet protocol packet, retransmitting the voice over internet protocol packet using the allocated different uplink resource.

The method may further include, at Block 10D′, in response to not receiving a subsequent uplink allocation, reverting to using the persistently assigned uplink resource for a next uplink transmission.

The various blocks shown in FIGS. 9 and 10 may be viewed as method steps, and/or as operations that result from operation of computer program code, and/or as a plurality of coupled logic circuit elements constructed to carry out the associated function(s).

The exemplary embodiments of this invention also provide an apparatus, such as the eNB 12, that includes means for transceiving uplink and downlink radio frequency communications with a plurality of user equipment, and means for determining if a collision will occur between a transmission from a first user equipment, that uses a persistently assigned uplink resource for transmitting VoIP packets, and a retransmission from a second user equipment that uses synchronous non-adaptive HARQ for retransmitting data in response to receipt of a NACK. The determining means is configurable to respond to a determination that the collision will occur for dynamically allocating the first user equipment a different uplink resource block for transmission of a next VoIP packet to avoid the collision, and for signaling information to the first user equipment via the transceiver means for identifying the different uplink resource block.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the E-UTRAN (UTRAN-LTE) system, it should be appreciated that the exemplary embodiments of this invention are not limited for use with only this one particular type of wireless communication system, and that they may be used to advantage in other wireless communication systems. Further, the exemplary embodiments are not limited for use with only VoIP packet transmissions that are subject to persistent scheduling, and they may be used with other types of UL transmissions that benefit from the use of persistent scheduling.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
determining if a collision will occur between a transmission from a first user equipment that uses a persistently assigned uplink resource and a retransmission from a second user equipment that uses a synchronous non-adaptive automatic repeat request procedure; and
if it is determined that a collision will occur, dynamically allocating the first user equipment to another uplink resource to avoid the collision;
if it is determined that the collision will not occur, the first user equipment is not dynamically allocated another uplink resource so that the first user equipment sends its transmission using the persistently assigned uplink resource.

2. The method of claim 1, where the first user equipment is dynamically allocated the another uplink resource using L1/L2 control signaling.

3. The method of claim 1, where the first user equipment is dynamically allocated the another uplink resource using a short grant procedure.

4. The method of claim 1, where the first user equipment uses the persistently assigned uplink resource for sending voice over internet protocol-packets.

5. The method of claim 1, where the automatic repeat request procedure is a synchronous, non-adaptive hybrid automatic repeat request (HARQ) procedure.

6. The method of claim 1, executed at least in part by a scheduler function of an evolved Node-B.

7. The method of claim 1, performed as a result of execution of computer program instructions stored in a computer readable memory medium.

8. An apparatus, comprising:
a radio frequency transceiver configurable to perform uplink and downlink radio frequency communications with a plurality of user equipment; and
a scheduler responsive to a determination being made that a collision will occur between a transmission from a first user equipment, that is allocated a persistently assigned uplink resource, and a retransmission from a second user equipment that uses a synchronous non-adaptive automatic repeat request procedure, to allocate the first user equipment a different uplink resource for the transmission to avoid the collision.

9. The apparatus of claim 8, where the first user equipment is allocated the different uplink resource using L1/L2 control signaling.

10. The apparatus of claim 8, where the first user equipment is allocated the different uplink resource using a short grant.

11. The apparatus of claim 8, where the first user equipment uses the persistently assigned uplink resource for sending voice over internet protocol packets.

12. The apparatus of claim 8, where the automatic repeat request procedure is a synchronous, non-adaptive hybrid automatic repeat request (HARQ) procedure.

13. The apparatus of claim 8, embodied in an evolved Node-B.

14. An apparatus, comprising:
means for transceiving uplink and downlink radio frequency communications with a plurality of user equipment; and
means for determining if a collision will occur between a transmission from a first user equipment, that uses a persistently assigned uplink resource for transmitting VoIP packets, and a retransmission from a second user equipment that uses synchronous non-adaptive HARQ for retransmitting data in response to receipt of a NACK, said determining means configurable to respond to a determination that the collision will occur for dynamically allocating the first user equipment a different uplink resource block for transmission of a next VoIP packet to avoid the collision, and for signaling information to the first user equipment via said transceiver means for identifying the different uplink resource block.

15. The apparatus of claim 14, where the information is signaled using a short grant procedure.

16. A method, comprising:
monitoring a downlink control channel when operating a user equipment with a persistently assigned uplink resource; and
in response to receiving an allocation of a different uplink resource from the downlink control channel, using the allocated different uplink resource to transmit a next packet.

17. The method of claim 16, where the allocated different uplink resource is predetermined to avoid a collision between the transmission of the packet and a retransmission from another user equipment, and in response to not receiving a subsequent uplink allocation, reverting to using the persistently assigned uplink resource for a next uplink transmission.

18. The method of claim 16, where in response to retransmission being needed for the transmitted next packet, retransmitting the packet using the allocated different uplink resource.

19. The method of claim 16, where the next packet comprises a voice over internet protocol packet.

20. The method of claim 16, performed as a result of execution of computer program instructions stored in a computer readable memory medium.

21. An apparatus, comprising:
a radio frequency transceiver configurable to perform uplink and downlink radio frequency communications with a base station; and
a controller coupled with the transceiver and configurable to monitor a downlink control channel, when operating with a persistently assigned uplink resource, to receive an allocation of a different uplink resource from the downlink control channel, said controller further configurable to use the allocated different uplink resource to transmit a next packet.

22. The apparatus of claim 21, where the allocated different uplink resource is predetermined at the base station to avoid a collision between the transmission of the next packet and a retransmission from another user equipment, and where said controller is further configurable, in response to not receiving a subsequent UL allocation, to revert to using the persistently assigned uplink resource for a next uplink transmission.

23. The apparatus of claim 21, where in response to retransmission being needed for the transmitted next packet, said controller is further configurable to retransmit the packet using the allocated different uplink resource.

24. The apparatus of claim 21, where the allocation is received using L1/L2 control signaling, and may comprise a short grant procedure.

25. The apparatus of claim 21, where the next packet comprises a voice over internet protocol packet.
